(19) United States
(12) Patent Application Publication
(10) Pub. No.: US 2015/0370297 A1
(43) Pub. Date: Dec. 24, 2015

(54) MODULAR POWER DISTRIBUTION FOR COMPUTING SYSTEMS

(71) Applicant: Microsoft Corporation, Redmond, WA (US)

(72) Inventors: James Darrin Schroeder, San Antonio, TX (US); Shaun Harris, College Station, TX (US)

(21) Appl. No.: 14/308,645

(22) Filed: Jun. 18, 2014

(51) Int. Cl. G06F 1/26; G06F 1/28

(52) U.S. Cl. CPC G06F 1/266; G06F 1/28

(57) ABSTRACT

Various techniques for modular power distribution in computing facilities are described herein. In one embodiment, a power distribution unit includes a first subsystem for receiving power from a power source. A configuration of the first subsystem corresponds to one or more characteristics of the power source. The power distribution unit also includes a second subsystem electrically coupled to one or more of processing units in a component enclosure. A configuration of the second subsystem is independent from the one or more characteristics of the power source. A set of connectors electrically couple the first subsystem to the second subsystem allowing the power from the power source to flow from the first subsystem, via the second subsystem, and to the processing units in the component enclosure.

### BACKGROUND

Modern data centers and other computing facilities can have thousands of servers, input/output modules, routers, switches, and other types of processing units supported by a common utility infrastructure. For example, the utility infrastructure can provide power distribution that supply power to the individual processing units from a power grid, a battery bank, a diesel generator, or other power sources. In another example, the utility infrastructure can also include transformers, rectifiers, voltage regulators, circuit breakers, or other types of electrical/mechanical components that condition, monitor, and/or regulate the supplied power.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain computing facilities, individual component enclosures can house multiple servers, input/output modules, routers, switches, and/or other types of processing units. Each component enclosure can also include a power distribution unit (“PDU”) that provides power to the processing units. The PDU typically can include one or more plugs, breakers, cords, receptacles, metal housings, and/or other electrical/mechanical components arranged in circuits that distribute power from a main power source to the individual processing units.

Certain components of PDUs may be location or power-system specific. For example, power systems in Europe are primarily 400-volt AC phase-to-neutral while those in the United States can be 208-volt AC phase-to-phase. As a result, PDUs and associated component assemblies for Europe may require different plugs, breakers, or other components than those for the United States even though the component assemblies may contain the same configuration of processing units. Such difference in PDU components may increase manufacturing complexities of component assemblies and/or component enclosures, and may also lead to production or deployment delays or installation errors.

Several embodiments of the present technology are directed to modular power distribution in which component assemblies of a single configuration of processing units may be suitable for multiple locations or power systems. For example, a PDU according to one embodiment of the present technology may be divided into a first subsystem that is location specific and a second subsystem that is assembly specific. The first subsystem can include plugs, breakers, cords, and/or other electrical/mechanical components arranged in circuits based on and suitable for particular voltage/current ratings, source topology, grounding requirements, and/or other power system characteristics. The second subsystem can include receptacles, cords, or other components that are independent of the characteristics of the particular power system, but are suitable to the particular requirements of the processing units.

The first and second subsystems can each include a connector configured to mate with each other. Each connector can include multiple conductors configured to allow electrical power to flow from the first subsystem, via the second subsystem, to the processing units. In certain embodiments, the connectors may be universal or common for all types of power systems. As a result, component assemblies with a single configuration of processing units may be manufactured for multiple locations irrespective of the particular power system characteristics at such locations. Thus, manufacturing complexities and production delays of component assemblies of processing units may be reduced when compared to conventional techniques.

Certain embodiments of the present technology can also reduce capital costs for upgrading data centers or other types of computing facilities. Unlike conventional techniques in which PDUs are fully replaced with component assemblies of processing units, certain components of PDUs in accordance with the present technology may be retained and reutilized during upgrades. For example, the first subsystem of the PDUs may be reused while only the second subsystem is replaced with component assemblies to accommodate upgraded processing units. As a result, the first subsystem may be depreciated over a longer period of time than the second subsystem, and thus reducing capital costs of facility upgrades.

### BRIEF DESCRIPTION OF THE DRAWINGS

FIG. 1 is a schematic diagram illustrating a computer framework having modular power distribution configured in accordance with embodiments of the present technology.

FIGS. 2A and 2B are schematic diagrams illustrating certain components suitable for the power distribution unit of FIG. 1 in accordance with embodiments of the present technology.

FIG. 3 is a schematic diagram illustrating a computing assembly having a portion of a power distribution unit in accordance with embodiments of the present technology.

### DETAILED DESCRIPTION

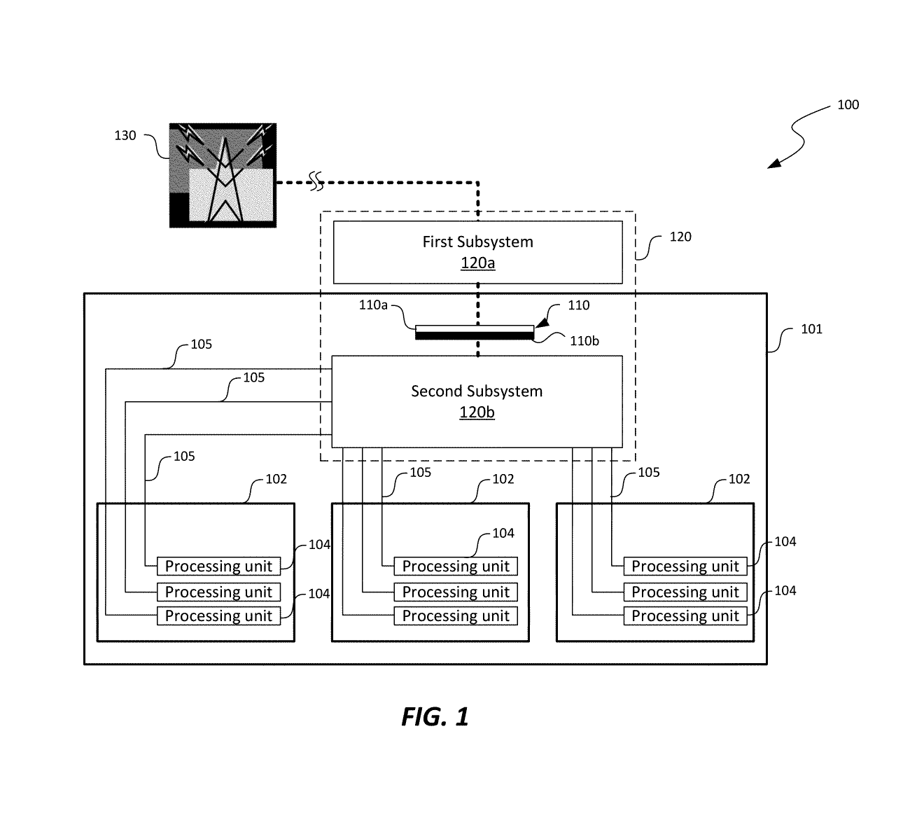

Certain embodiments of systems, devices, components, modules, routines, and processes for modular power distribution in computing facilities are described below. In the following description, specific details of components are included to provide a thorough understanding of certain embodiments of the present technology. A person skilled in the relevant art will also understand that the technology may have additional embodiments. The technology may also be practiced without several of the details of the embodiments described below with reference to FIGS. 1-3.

As used herein, the term “power distribution unit” or “PDU” generally refers to an apparatus with multiple power outlets configured to supply and/or distribute electrical power from a power source to multiple electrical or electronic devices. PDUs may be floor mounted, enclosure mounted, rack mounted, or may have other suitable structural profiles. Certain example PDUs may contain one or more power conversion and/or conditioning components that condition and/or transform one or more larger capacity power feeds into multiple lower-capacity power feeds. Example power conversion and/or conditioning components include transformers, circuit breakers, power filters, and power rectifiers. In other examples, PDUs may simply include a number of appliance or interconnection couplers.

Also used herein, the term “processing unit” generally refers to an electrical or electronic apparatus configured to perform logic comparisons, arithmetic calculations, electronic communications, electronic input/output, and/or other suitable functions when supplied with electrical power. Example processing units can include computing systems (e.g., servers, computers, etc.), computing devices (e.g., logic processors, network routers, network switches, network interface cards, data storage devices, etc.), or other suitable types of electronic apparatus. Multiple processing units may be organized into a component assembly and be carried by a rack, rail, or other suitable types of support component. Also used herein, the term “rack” or “rail” generally refers to a frame or enclosure into or onto which one or more processing units may be mounted.

Also used herein, the term “connector” or “electrical connector” generally refers to an electro-mechanical device or assembly configured as an interface for coupling electrical circuits. A connector may include a housing that may have any of many mechanical forms. For example, a connector may include a plug or a socket that mates with the plug. In another example, a connector can be a coaxial connector, a Molex connector, or of other suitable types of connector. A connector may also include multiple conductors (e.g., wires) configured to carry power and/or signals. The conductors may be electrically parallel to and insulated from one another.

As discussed above, power source characteristics at different locations may require different component assemblies with different PDUs in accordance with conventional techniques. As a result, manufacturing of the component assemblies may be complex and prone to production or deployment delays. Several embodiments of the present technology divide a PDU into a location-specific subsystem and an assembly-specific subsystem. The location-specific subsystem may be configured to receive power from a power source with certain characteristics (e.g., 3-phase AC at 208 volts phase-to-phase) at a particular location and output a power supply of a particular configuration (e.g., single-phase AC at 120 volts phase-to-neutral). The assembly-specific subsystem may be configured to receive power from the power supply of the location-specific subsystem and provide the received power to the processing units. As a result, the assembly-specific subsystem of the PDU can be independent from the characteristics of the power source at the location, rendering the component assembly suitable for multiple locations with different power supply characteristics.

FIG. 1 is a schematic diagram illustrating a computing framework 100 having modular power distribution configured in accordance with embodiments of the present technology. As shown in FIG. 1, the computing framework 100 can include a power source 130, a component enclosure 101 holding a plurality of processing units 104 organized in component assemblies 102, and a PDU 120 (shown in phantom lines for clarity) electrically coupling the power source 130 to the individual processing units 104. Even though particular components of the computing framework 100 is shown in FIG. 1, in other embodiments, the computing framework 100 can also include computer network components, supervisory stations, and/or other suitable components.

In the illustrated embodiment, the power source 130 includes a utility power grid with one or more characteristics. For example, the utility power grid may have at least one of a particular voltage rating, current rating, source topology (e.g., delta or wye), grounding requirement, plug specification, and/or other electrical/mechanical characteristics based on a location (e.g., country or territory), primary use (e.g., commercial or residential), and/or other suitable factors. As discussed in more detail below, a portion of the PDU 120 may be configured based on and/or corresponding to the one or more characteristics of the power source 130. As a result, the PDU 120 may receive and distribute power from the power source 130 to the processing units 104. Even though the power source 130 is shown in FIG. 1 as a utility power grid, in other embodiments, the power source 130 can also include a battery bank, a diesel generator, and/or other suitable power sources with corresponding characteristics.

The component enclosure 101 can have a size and dimension configured to contain the processing units 104. For example, though not shown in FIG. 1, the component enclosure 101 can include a housing having an accessible door, a ventilation fan, one or more temperature sensors, one or more intercoolers, and/or other suitable components. In other examples, the component enclosure 101 can also include a structural frame with or without front, side, or back panels. In further examples, the component enclosure 101 can also include a shipping container and/or other suitable enclosing components. Even though only one component enclosure 101 and three component assemblies 102 are shown in FIG. 1, in other embodiments, the computing framework 100 can include other suitable number of component enclosures 101 and/or component assemblies 102 in any suitable arrangements.

The processing units 104 can be configured to implement one or more computing applications, network communications, input/output capabilities, and/or other suitable functionalities, for example, as requested by the users 101. In certain embodiments, the processing units 104 can include web servers, application servers, database servers, and/or other suitable computing components. In other embodiments, the processing units can include routers, network switches, analog/digital input/output modules, modems, and/or other suitable electronic components. FIG. 1 shows three processing units 104 in each of the component assemblies 102 for illustration purposes. In other embodiments, any other suitable numbers of processing units 104 with generally similar or different configurations may reside in each of the component assemblies 102, in the component enclosure 102, or in additional component enclosures (not shown).

As shown in FIG. 1, the PDU 120 can include a first subsystem 120a, a second subsystem 120b, and a set of connectors 110 electrically coupling the first and second subsystems 120a and 120b. The first subsystem 120a can be configured to receive power from the power source 130. The set of connectors 110 then allow the received power to flow from the first subsystem 120a to the second subsystem 120b. The second subsystem 120b can be electrically coupled to the individual processing units 104 via a plurality of electrically parallel wires 105 to provide the received power to the individual processing units 104. In the illustrated embodiment, the first subsystem 120a is shown outside of the component enclosure 101 while the set of connectors 110 and the second subsystem 120b are shown inside the component enclosure 101. In other embodiments, the set of connectors 110 may be outside of the component enclosure 101. In further embodiments, all components of the PDU 120 may be inside the component enclosure 101 or may have other suitable arrangements.

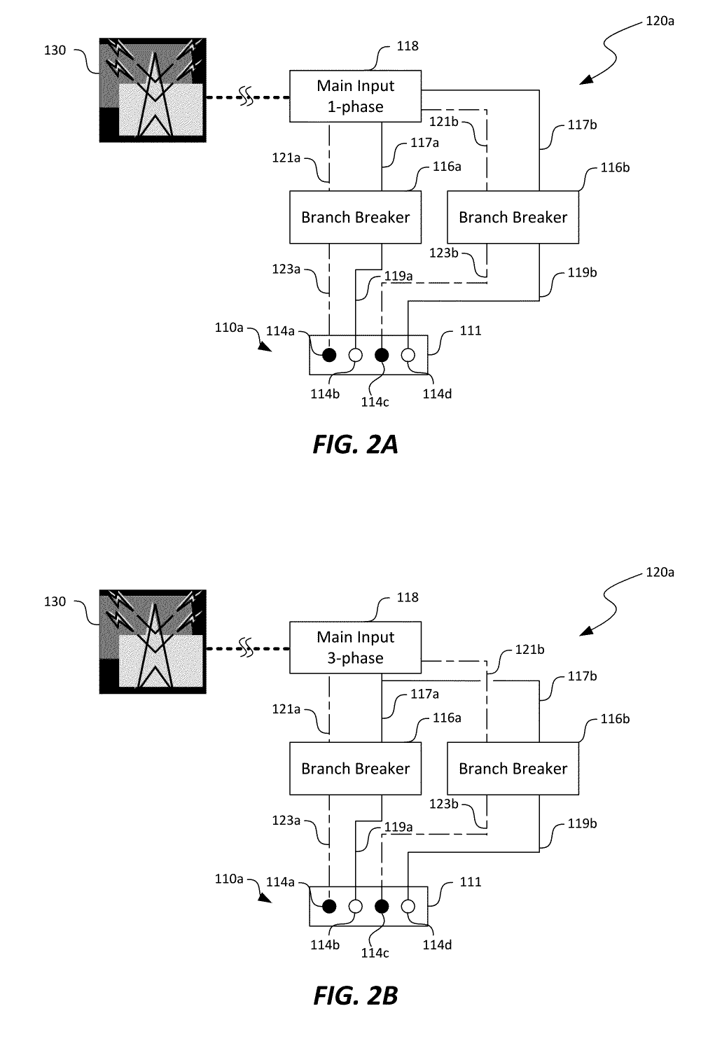

The first subsystem 120a can be configured in accordance to the one or more characteristics of the power source 130 in order to receive power therefrom (herein referred to as “location specific”). In certain embodiments, the first subsystem 120a may include electrical components arranged in a circuit corresponding to the one or more characteristics of the power source 130. For example, the power source 130 may have a voltage rating of 400-volt AC phase-to-neutral in a delta topology. Based on such characteristics, the first subsystem 120a may include one or more plugs, breakers, transformers, or cords with ratings corresponding to 400-volt AC. The first subsystem 120a can also include suitable circuits that distribute the received power in a delta topology to multiple electrically parallel branches. In another example, if the power source 130 has a voltage rating of 208-volt AC in a wye topology, then components of the first subsystem 120a may have different ratings and/or specifications as well as different circuits to distribute the received power. One example first subsystem 120a is described in more detail below with reference to FIGS. 2A and 2B.

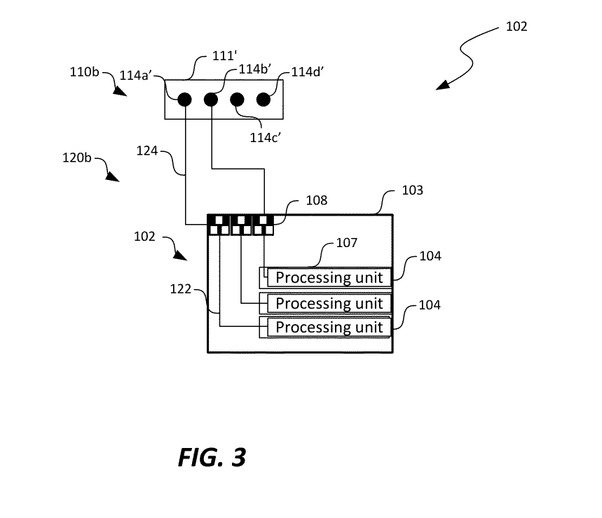

The second subsystem 120b can be configured independently from the one or more characteristics of the power source 130 but instead based on characteristics of the processing units 104 (herein referred to as “assembly specific”) in the component assemblies 102. For example, the second subsystem 120b can include receptacles, cords, or other components arranged in circuits that correspond to configurations of the processing units 104 in the component assemblies 102. The receptacles, cords, or other components, however, can be selected, designed, and/or otherwise provided irrespective of the characteristics of the power source 130. Thus, the second subsystem 120b may be common or “universal” for most or all locations irrespective of the characteristics of the power source 130. As a result, component assemblies 102 with a single configuration of the processing units 104 may be manufactured for multiple locations, and thus reducing manufacturing complexities and production delays when compared to conventional techniques. One example second subsystem 120b is described in more detail below with reference to FIG. 3.

The set of connectors 110 can be configured independently from the characteristics of the power source 130 to electrically connect the first subsystem 120a to the second subsystem 120b. The set of connectors 110 can mate with each other in any suitable fashion. For example, the set of connectors 110 can include a plug and a socket configured to mate with the plug. In the illustrated embodiment, the set of connectors 110 are shown as a first connector 110a associated with the first subsystem 120a and a second connector 110b associated with the second subsystem 120b of the PDU 120 located inside the component enclosure 101. In other embodiments, the set of connectors 110 may include multiple subsets of connectors or may have other suitable arrangements located outside the component enclosure 101 or at other suitable locations. One example set of connectors 110 is described in more detail below with reference to FIGS. 2 and 3.

In operation, the first subsystem 120a of the PDU 120 receives power from the power source 130. The first subsystem 120a can then distribute the received power into multiple branches. The set of connectors 110 can allow the distributed power to flow along the multiple branches from the first subsystem 120a, via the second subsystem, and to the processing units 104 in the individual component assemblies 102 of the component enclosure 101.

Certain embodiments of the computing framework 100 can reduce capital costs for hardware upgrades. Unlike conventional systems in which PDUs are fully replaced with component assemblies 102 of processing units 104, the location specific first subsystem 120a of the PDU 120 may be retained and reutilized during upgrades. Only the assembly specific second subsystem 120b may require replacement to accommodate upgraded processing units 104 in the component assemblies 102. As a result, the first subsystem 120a may be depreciated over a longer period of time (e.g., a 15-year depreciation cycle) than the second subsystem 120b (e.g., a 3-year depreciation cycle), and thus reducing capital costs during hardware upgrades. Certain embodiments of the computing framework 100 can also reduce inventory of hardware components. Conventional techniques may require an inventory of different component assemblies with different power configurations even though the component assemblies all contain the same configuration of processing units. In contrast, the present technology can provide component assemblies with a single configuration suitable for most or all locations with different power systems.

FIGS. 2A and 2B are schematic diagrams illustrating an example first subsystem 120a and first connector 110a suitable for the PDU 120 of FIG. 1 in accordance with embodiments of the present technology. As shown in FIGS. 2A and 2B, the first subsystem 120a can include a plurality of branch breakers 116 (shown individually as first and second branch breakers 116a and 116b) and a plurality of wires 117 electrically connecting the branch breakers 116 to a main input 118 to form a plurality of branch circuits 115. For example, the first branch breaker 116a is electrically connected to the voltage and neutral lines of the main input 118 via a wire 117a and a wire 121a, respectively. The second branch breaker 116b is electrically connected to the voltage and neutral lines of the main input 118 via a wire 117b and a wire 121b, respectively. In FIG. 2A, the main input 118 is shown as a single phase feed for illustration purposes. As such, both the wires 117a and 117b are connected to the voltage line of the main input 118. In other embodiments, the main input 118 can also include three phase delta or three phase wye in which the wires 117a, 117b, 121a, and 121b may be electrically connected to various combination of voltage and/or neutral lines of the main input 118. For example, as shown in FIG. 2B, the first and second branch breakers 116a and 116b can share a common line of the main input 118 via the wires 117a and 117b while individually connected to other lines of the main input 118 via the wires 121a and 121b. In the illustrated embodiment of FIGS. 2A and 2B, two branch breakers 116 in two branch circuits 115 electrically parallel to one another are shown for illustration purposes. In other embodiments, the first subsystem 120a can include three, four, or any other suitable branch breakers 116 and associated branch circuits. In further embodiments, the branch breakers 116 may be omitted.

As shown in FIGS. 2A and 2B, the first connector 110a can include a housing 111 holding multiple conductors 114 (shown individually as first, second, third, and fourth conductors 114a-114d, respectively). The multiple conductors 114 are electrically parallel to and electrically insulated from one another. In certain embodiments, a plurality of wires 119 directly connect the individual branch breakers 116 to one of the conductors 114 in the first connector 110a. For example, the first branch breaker 116a is connected to the first and second conductors 114a and 114b via a neutral wire 123a and a wire 119a. The second branch breaker 116b is connected to the third and fourth conductors 114c and 114d via a neutral wire 123b and a wire 119b. In other embodiments, a ground wire (not shown) can also connect the main input 118 to one of the conductors 114 (not shown). As mentioned above, the first connector 110a is configured to mate with the second connector 110b as described in more detail below with reference to FIG. 3.

FIG. 3 is a schematic diagram illustrating an example component assembly 102 having a second connector 110b and an example second subsystem 120b of the PDU 120 in FIG. 1 in accordance with embodiments of the present technology. In FIG. 3, only one component assembly 102 with corresponding processing units 104 electrically coupled to the second connector 110b are shown for illustration purposes. Additional component assemblies 102 with corresponding processing units 104 also electrically coupled to the second connector 110b are not shown for clarity.

As shown in FIG. 3, the second connector 110b can have a configuration suitable to mate with the first connector 110a. For example, the second connector 110b can include a housing 111′ holding multiple conductors 114′ (shown individually as first, second, third, and fourth conductors 114a′-114d′, respectively). Each of the conductors 114a′-114d′ may be configured to mate with a corresponding conductor 114a-114d (FIG. 2) of the first connector 110a, respectively. In other embodiments, the second connector 110b may have a configuration different than that of the first connector 110a by, for example, having additional or different conductors, conductor arrangements, housing designs, and/or other characteristics.

As shown in FIG. 3, the second subsystem 120b can include a plurality of receptacles 108 individually connected to one of the processing units 104 via corresponding wires 122. The processing units 104 are individually received and held in corresponding slot 107 in a frame 103 of the component assembly 102. The set of wires 124 directly connect the receptacles 108 in the component assembly 102 to one or more conductors 114′ of the second connector 110b. In the illustrated embodiment, the receptacles 108 are connected to the first conductor 114a′ and the second conductor 114b′ in a single branch circuit. In other embodiments, at least one of the receptacles 108 may be connected in an additional branch circuit (not shown). In further embodiments, additional receptacles 108 (not shown) associated with other component assemblies 102 (not shown) may be connected to the second or third conductors 114c and 114d.

Even though the receptacles 108 are shown in FIG. 3 as being carried by, installed in, or incorporated into the frame 103 of the component assembly 102, in other embodiments, the receptacles 108 may be separate from the frame 103 of the component assembly 102 or having other suitable arrangements. In further embodiments, the receptacles 108 may be omitted, and the processing units 104 may be directed connected to the individual conductors 114′ of the second connector 110b via suitable wires (not shown). In yet further embodiments, the second subsystem 120b may also include surge protectors, voltage monitors, and/or other suitable types of electrical/mechanical components. In yet other embodiments, the first and/or second subsystems 120a and 120b of the PDU 120 may also include one or more monitoring components (e.g., voltage monitors, current monitors, etc.), control components (e.g., remote power cycling controllers), and/or other suitable electrical components.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/we claim:

1. A power distribution unit (“PDU”) for a component enclosure having a plurality of processing units, the PDU comprising:
a first subsystem for receiving power from a power source, a configuration of the first subsystem corresponding to one or more characteristics of the power source;
a second subsystem electrically coupled to one or more of the processing units in the component enclosure, a configuration of the second subsystem being independent from the one or more characteristics of the power source; and
a set of connectors electrically coupling the first subsystem to the second subsystem allowing the power from the power source to flow from the first subsystem, via the second subsystem, and to the processing units in the component enclosure.

2. The power distribution unit of claim 1 wherein the first subsystem includes at least one of a plug, a breaker, a receptacle, or a cord arranged in a circuit corresponding to the one or more characteristics of the power source, the one or more characteristics including at least one of a voltage rating, a current rating, a source topology, a grounding requirement, or a plug specification.

3. The power distribution unit of claim 1 wherein:
the set of connectors include a first connector associated with the first subsystem; and
the first subsystem includes a plurality of branch breakers coupled to a main input, the branch breakers being electrically parallel to one another and each electrically coupled to the first connector.

4. The power distribution unit of claim 1 wherein:
the set of connectors include a first connector associated with the first subsystem, the first connector having a plurality of conductors electrically insulated from one another; and
the first subsystem includes a plurality of branch breakers coupled to a main input, the branch breakers being electrically parallel to one another and each electrically coupled to one of the conductors of the first connector.

5. The power distribution unit of claim 1 wherein:
the set of connectors include a first connector associated with the first subsystem, the first connector having a plurality of conductors electrically insulated from one another; and
the first subsystem includes:
a plurality of branch breakers coupled to a main input, the branch breakers being electrically parallel to one another; and
a plurality of conductive wires individually and electrically coupling one of the branch breakers to one of the conductors of the first connector.

6. The power distribution unit of claim 1 wherein:
the set of connectors include a first connector associated with the first subsystem, the first connector having a plurality of conductors electrically insulated from one another; and
the first subsystem includes:
a plurality of branch breakers coupled to a main input, the branch breakers being electrically parallel to one another; and
a plurality of conductive wires individually and directly connecting one of the branch breakers to one of the conductors of the first connector.

7. The power distribution unit of claim 1 wherein:
the set of connectors include a first connector associated with the first subsystem and a second connector associated with the second subsystem, the first and second connectors individually having a plurality of conductors electrically insulated from one another;
the first subsystem includes a plurality of branch breakers coupled to a main input, the branch breakers being electrically parallel to one another and each electrically coupled to one of the conductors of the first connector; and
the second subsystem includes a plurality of receptacles each electrically coupled to one of the conductors of the second connector.

8. The power distribution unit of claim 1 wherein:
the set of connectors include a first connector associated with the first subsystem and a second connector associated with the second subsystem, the first and second connectors individually having a plurality of conductors electrically insulated from one another;
the first subsystem includes a plurality of branch breakers coupled to a main input, the branch breakers being electrically parallel to one another and each electrically coupled to one of the conductors of the first connector; and
the second subsystem includes a plurality of receptacles each electrically coupled to one of the conductors of the second connector, at least one of the plurality of receptacles being attached to the component enclosure and corresponding to one of the processing units in the component enclosure.

9. The power distribution unit of claim 1 wherein the first subsystem is located outside of the component enclosure, and wherein the second subsystem and the set of connectors are located inside the component enclosure.

10. The power distribution unit of claim 1 wherein the first subsystem, the second subsystem, and the set of connectors are located inside the component enclosure.

11. The power distribution unit of claim 1 wherein the set of connectors have a configuration independent of the one or more characteristics of the power source.

12. A power distribution unit (“PDU”) for a component enclosure having a plurality of processing units, the PDU comprising:
a plurality of branch breakers electrically coupled to a main input, the plurality of branch breakers being arranged in parallel to one another electrically;
a connector having a plurality of conductors electrically insulated from one another; and
a plurality of conductive wires individually connecting one of the branch breakers to one of the conductors in the connector, wherein the branch breakers have a configuration corresponding to one or more characteristics of the power source.

13. The power distribution unit of claim 12 wherein the one or more characteristics of the power source includes at least one of a voltage rating, a current rating, a source topology, or a grounding requirement.

14. The power distribution unit of claim 12 wherein the plurality of conductive wires directly connect one of the branch breakers to one of the conductors in the connector.

15. The power distribution unit of claim 12 wherein the connector has a configuration independent of the one or more characteristics of the power source.

16. A computing assembly, comprising:
one or more electronic modules individually having a computing processor;
a component assembly having a frame configured to receive the electronic modules; and
a power distribution unit including:
a plurality of receptacles carried by the frame of the component assembly, each of the plurality of receptacles being electrically coupled to one of the electronic modules received in the component assembly;
a connector having a plurality of conductors electrically parallel to and electrically insulated from one another; and
a plurality of conductive wires each electrically connecting one of the plurality of receptacles to one of the conductors of the connector.

17. The computing assembly of claim 16 wherein the computing assembly is configured to receive power from a power source having one or more characteristics, and wherein a configuration of the plurality of receptacles is independent of the one or more characteristics of the power source.

18. The computing assembly of claim 16 wherein the computing assembly is configured to receive power from a power source having one or more characteristics, and wherein a configuration of the connector is independent of the one or more characteristics of the power source.

19. The computing assembly of claim 16 wherein the plurality of conductive wires each directly connecting one of the plurality of receptacles to one of the conductors of the connector.

20. The computing assembly of claim 16 wherein the power distribution unit consisting essentially of the plurality of receptacles, the connector, and the plurality of conductive wires.
